(19) United States
(12) Patent Application Publication
(10) Pub. No.: US 2020/0172286 A1
(43) Pub. Date: Jun. 4, 2020

(54) Right-Angle Turning and Connecting Device for Thick-Board Cartons

(71) Applicant: Dongguan Uni-Packing Technology Office, Dongguan, Guangdong Province (CN)

(72) Inventor: Tingwu XUE, Dongguan (CN)

(21) Appl. No.: 16/309,430

(22) PCT Filed: Sep. 30, 2017
(86) PCT No.: PCT/CN2017/104692

§ 371 Date: Dec. 12, 2018

(30) Foreign Application Priority Data
Sep. 5, 2017 (CN) 201721138973.7

(51) Int. Cl. B65D 5/42; B31B 100/00

(52) U.S. Cl. CPC B65D 5/4266; B65D 5/4295; B65D 5/4208; B65D 2571/00728; B65D 5/4279; B31B 2100/00

(57) ABSTRACT

The utility model discloses a right-angle turning and connecting device for thick-board cartons, comprising a corner inside face and a corner outside face, wherein the corner inside face comprises a first inside face and a second inside face; the first inside face and the second inside face are in an L-shaped right-angle connection; the joint between the first inside face and the second inside face is a corner axis; the corner inside face and the corner outside face are axially symmetric to each other along the corner axis; the corner inside face and the corner outside face are connected along the corner axis; the corner outside face comprises a first outside face, a second outside face, a third outside face and a fourth outside face; the first outside face and the second outside face, the second outside face and the third outside face, the third outside face and the fourth outside face are respectively in a right-angle connection two-by-two; the first outside face, the second outside face, the third outside face and the fourth outside face are connected in turn and are arranged in an M shape. The right-angle turning and connecting device for thick-board cartons solves the problem that thick paper boards cannot be turned and folded, and saves space.

### BACKGROUND OF THE UTILITY MODEL

### Technical Field

The utility model relates to the technical field of folding devices, in particular to a right-angle turning and connecting device for thick-board cartons.

### Description of Related Art

Cartons are usually used to package products to fix fragile and vulnerable articles therein and to prevent products from damaging and deforming, and cartons can resist various impacts, vibration, bumping, compression, friction, etc. during loading, transport and storage, protect inside products, and have a certain vibration resistance.

However, it is inconvenient to fold and store existing thick-board cartons because of thick carton walls, resulting in occupation of large space, and inconvenience in stacking and transport.

### BRIEF SUMMARY OF THE UTILITY MODEL

An objective of the utility model is to provide a right-angle turning and connecting device for thick-board cartons, which solves the problem that it is difficult to fold thick paper boards, can effectively fold and store thick paper boards, and saves space, to solve the problems put forward in the above-mentioned Description of the Related Art.

To achieve the above objective, the utility model provides the following technical solution:

A right-angle turning and connecting device for thick-board cartons includes a corner inside face and a corner outside face, wherein the corner inside face includes a first inside face and a second inside face; the first inside face and the second inside face are in an L-shaped right-angle connection; the joint between the first inside face and the second inside face is a corner axis; the corner inside face and the corner outside face are axially symmetric to each other along the corner axis; the corner inside face and the corner outside face are connected along the corner axis; the corner outside face includes a first outside face, a second outside face, a third outside face and a fourth outside face; the first outside face and the second outside face, the second outside face and the third outside face, the third outside face and the fourth outside face are respectively in a right-angle connection two-by-two; the first outside face, the second outside face, the third outside face and the fourth outside face are connected in turn and are arranged in an M shape.

Preferably, the corner inside face and corner outside face are both foldable members.

Preferably, the corner inside face and corner outside face are in a spliced or nailed or sutured connection through the corner axis.

Preferably, the first inside face and the first outside face, and the second inside face and the fourth outside face are respectively spliced with two adjacent faces of a carton through adhesive.

Compared with the prior art, the utility model has the following beneficial effects:

For the right-angle turning and connecting device for thick-board cartons, the joint between the first inside face and the second inside face serves as the corner axis; the corner inside face and the corner outside face are symmetrically arranged along corner axis; the corner inside face and the corner outside face are connected along the corner axis; the corner inside face and the corner outside face are both foldable members; the corner inside face and the corner outside face are superimposed when folded; the first inside face and the first outside face, and the second inside face and the fourth outside face are respectively spliced with two adjacent faces of a carton through adhesive. The device has a simple structure, solves the problem that it is difficult to fold thick paper boards, and saves space.

### BRIEF DESCRIPTION OF THE SEVERAL VIEWS OF THE DRAWINGS

FIG. 1 is an overall schematic view of the utility model;

FIG. 2 is a schematic view of connection between the utility model and a thick-board carton;

FIG. 3 is a partially amplified view in A-A direction when the utility model is connected with a thick-board carton.

As shown in the drawings, 1—corner inside face; 11—first inside face; 12—second inside face; 2—corner outside face; 21—first outside face; 22—second outside face; 23—third outside face; 24—fourth outside face; 3—corner axis.

### DETAILED DESCRIPTION OF THE UTILITY MODEL

The technical solutions in the embodiments of the utility model are clearly and completely described below in conjunction with the drawings in the embodiments of the utility model. Obviously, the described embodiments are merely some of the embodiments of the utility model, not all embodiments. Based on the embodiments of the utility model, all other embodiments made by those ordinarily skilled in the art without creative labor work shall fall within the protective scope of the utility model.

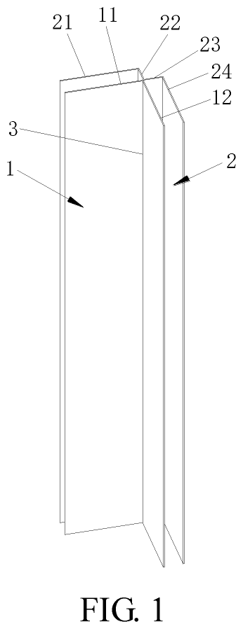

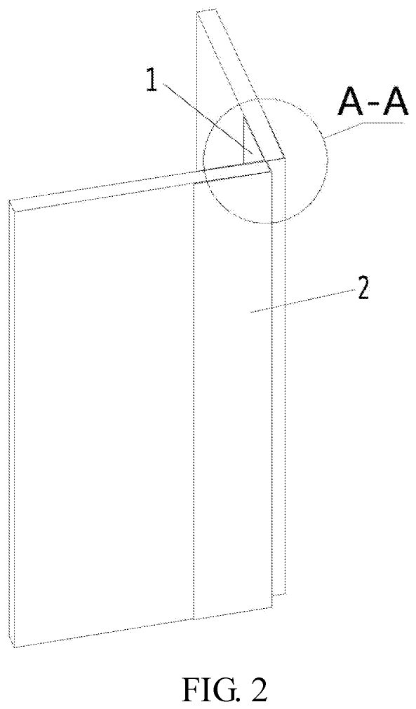

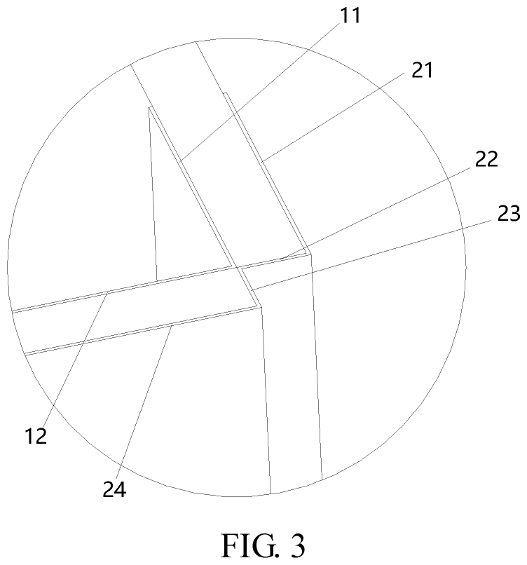

Referring to FIGS. 1-3, a right-angle turning and connecting device for thick-board cartons includes a corner inside face 1 and a corner outside face 2; the corner inside face 1 includes a first inside face 11 and a second inside face 12; the first inside face 11 and the second inside face 12 are in an L-shaped right-angle connection; the joint between the first inside face 11 and the second inside face 12 is a corner axis 3; the corner inside face 1 and the corner outside face 2 are axially symmetric to each other along the corner axis 3; the corner inside face 1 and the corner outside face 2 are connected along the corner axis 3; the corner inside face 1 and the corner outside face 2 are both foldable members. The corner outside face 2 includes a first outside face 21, a second outside face 22, a third outside face 23 and a fourth outside face 24; the first outside face 21 and the second outside face 22, the second outside face 22 and the third outside face 23, the third outside face 23 and the fourth outside face 24 are respectively in a right-angle connection two-by-two; and the first outside face 21, the second outside face 22, the third outside face 23 and the fourth outside face 24 are connected in turn and are arranged in an M shape. The first inside face 11 and the first outside face 21, and the second inside face 12 and the fourth outside face 24 are respectively spliced with two adjacent faces of a carton through adhesive. When the corner inside face 1 is folded inward along the corner axis 3, the first inside face 11 and the second inside face 12 are superimposed, and the first outside face 21 and the fourth outside face 24 are parallel to each other. When the corner inside face 1 is folded outward along the corner axis 3, the second outside face 22 and the third outside face 23 are superimposed, and the first outside face 21 and the fourth outside face 24 are on the same plane. The right-angle turning and connecting device for thick-board cartons has a simple structure, salves the problem that it is difficult to fold thick paper boards, and saves space. In use, two paper boards of the carton are respectively spliced between the first inside face 11 and the first outside face 21 and between the second inside face 12 and the fourth outside face 24; when the carton is open, the first inside face 11 and the second inside face 12 are stretched to form a right angle, and the first outside face 21, the second outside face 22, the third outside face 23 and the fourth outside face 24 are connected in turn and are arranged in an M shape on the exterior of the carton. When the carton is packed up, the whole carton is folded along the corner axis 3 to form a plane, thus facilitating stacking and saving occupied space.

In conclusion, for the right-angle turning and connecting device for thick-board cartons, the joint between the first inside face 11 and the second inside face 12 serves as the corner axis 3; the corner inside face 1 and the corner outside face 2 are symmetrically arranged along the corner axis 3; the corner inside face 1 and the corner outside face 2 are connected along the corner axis 3; the corner inside face 1 and the corner outside face 2 are both foldable member; the first inside face 11 and the first outside face 21, the second inside face 12 and the fourth outside face 24 are respectively spliced with the adjacent faces of the carton. The device is simple in structure, convenient in manufacturing, and capable of effectively folding and storing thick paper boards, and saves labor force.

For those skilled in the art, it is apparent that the utility model is not limited to the details of the above exemplary embodiments, and other specific forms can be adopted to implement the utility model under the condition of no departure from the concept or basic features of the utility model. Therefore, the embodiment shall be deemed to be exemplary regardless of being viewed from any point, instead of limited. The scope of the utility model is defined by the attached Claims instead of the above description. Thus, all changes made within the definitions and scope equivalent to those of the Claims shall fall within the scope of the utility model. Any drawing marks in the claims shall not be deemed to limit the claims.

Besides, it should be understood that the Specification is depicted according to the embodiment, but it is not the truth that every embodiment merely includes one independent technical solution. The depiction of the Specification is made for the only purpose of clearly describing the utility model. Those skilled in the art shall take the Specification as a whole. The technical solutions in respective embodiments can also be properly formed to form other embodiments that can be understood by those skilled in the art.

What is claimed is:

1. A right-angle turning and connecting device for thick-board cartons, comprising a corner inside face (1) and a corner outside face (2), characterized that the corner inside face (1) comprises a first inside face (11) and a second inside face (12); the first inside face (11) and the second inside face (12) are in an L-shaped right-angle connection; the joint between the first inside face (11) and the second inside face (12) is a corner axis (3); the corner inside face (1) and the corner outside face (2) are axially symmetric to each other along the corner axis (3); the corner inside face (1) and the corner outside face (2) are connected along the corner axis (3); the corner outside face (2) comprises a first outside face (21), a second outside face (22), a third outside face (23) and a fourth outside face (24); the first outside face (21) and the second outside face (22), the second outside face (22) and the third outside face (23), the third outside face (23) and the fourth outside face (24) are respectively in a right-angle connection two-by-two; the first outside face (21), the second outside face (22), the third outside face (23) and the fourth outside face (24) are connected in turn and are arranged in an M shape.

2. The right-angle turning and connecting device for thick-board cartons according to claim 1, wherein the corner inside face (1) and the corner outside face (2) are both foldable members.

3. The right-angle turning and connecting device for thick-board cartons according to claim 1, wherein the corner inside face (1) and the corner outside face (2) are in a spliced, nailed or sutured connection through the corner axis (3).

4. The right-angle turning and connecting device for thick-board cartons according to claim 1, wherein the first inside face (11) and the first outside face (21), and the second inside face (12) and the fourth outside face (24) are respectively spliced with two adjacent faces of a carton through adhesive.
